(19) United States
(12) Patent Application Publication
(10) Pub. No.: US 2003/0083044 A1
(43) Pub. Date: May 1, 2003

(54) Security system for portable electrical devices

(76) Inventors: Oliver Schreyer, Herzogenrath (DE); Thomas Falck, Aachen (DE); Henning Maass, Aachen (DE)

Correspondence Address: U.S. Philips Corporation, 580 White Plains Road, Tarrytown, NY, 10591, US

(21) Appl. No.: 10/277,584

(22) Filed: Oct. 22, 2002

(30) Foreign Application Priority Data
Oct. 25, 2001 (DE) 10152830.2

(51) Int. Cl. H04M 1/66; H04M 1/68; H04M 3/16

(52) U.S. Cl. 455/411; 455/410; 455/41

(57) ABSTRACT

The invention relates to a security system for portable devices (1 to 3). The security system consists of at least one portable transmitter unit (5), at least one portable receiver unit (6) and a reaction unit (7). The transmitter unit (5) regularly transmits a signal which is regularly received by the receiver unit (6) within a range of the signal. If the receiver unit (6) does not receive a signal, the reaction unit (7) generates a warning signal and/or activates a blocking mode, which renders a portable device to be protected (1 to 3) unusable.

The invention relates to a security system for a portable device with a transmitter unit and a receiver unit for protection against the unlawful removal or loss of the portable device. The invention further relates to a method for securing portable devices and a device protected by a security system.

Portable electrical devices such as a mobile telephone or walkman can be stolen without the owner of the device noticing that the theft has occurred. These devices are protected from unauthorized use in that a personal identification number has to be input before the device can be used. Electrical devices such as walkmans or personal digital assistants (PDAs) have no protection whatsoever from theft or unauthorized use. The theft of the device may take place unnoticed. The owner does not realize it has occurred until he finds the device is missing.

An arrangement to protect against the theft of electrical devices is known from document WO 93/144550 A1. The document describes several electrical devices protected with code numbers, which are arranged within a predetermined range. A transmitter emits the code numbers which are received by a receiver secured to the electrical device, and this receiver switches the devices into operating mode.

If the receiver does not receive any code numbers, the device is not serviceable and is separated from the power supply by a filter.

Owing to the interruption of the power supply, all devices located in the range of the filter are automatically taken out of operation. The electrical devices protected by the transmitter have to be coupled to a power network in order for protection to be guaranteed. Neither the arrangement nor the electrical devices cited within it are portable, and they are therefore unsuitable for portable entertainment-electronics devices.

It is an object of the invention to protect portable electronic devices from unlawful removal or loss.

The object is achieved by a security system of the kind specified above in that the security system consists of at least a portable transmitter unit and at least a portable receiver unit, in which:

every transmitter unit is provided for the regular sending of a signal

every receiver unit is provided, within a range of the signal, for the regular reception of the signal transmitted by the transmitter unit

a reaction unit is provided for generating a warning signal and/or for activating a locking mode, which renders a portable device to be protected unusable if the receiver unit does not receive a signal.

Portable devices, such as mobile telephones, portable cassette or CD recorders, can be protected from theft, unauthorized use or loss by a portable transmitter unit. The transmitter unit is carried on the body separately from the portable devices. To ensure that the devices are located within the range of the transmitter unit, they regularly emit a signal. Should a receiver unit integrated with the portable device fail to receive the signal, a reaction unit generates a warning signal to indicate the theft or loss of the device. Alternatively, or additionally, the reaction unit activates a blocking mode, which renders the device unusable.

Owing to the portable transmitter unit, the use of cables and other coupling means for securing the devices is superfluous. An owner can use the devices he wishes to protect without the devices having cabling and without their mobile characteristics having to be relinquished. Cordless protection can be implemented simply and economically.

The warning signal emitted by the device does not just draw attention to a theft acoustically, it also warns the owner of an unnoticed loss of the device. The transmitter unit may be deliberately removed from an area in which the lost device is presumed to be. Owing to the warning signal generated, the device can be acoustically located and retrieved.

To generate and transmit the signal, a short-distance transmitter is integrated with the transmitter unit. The short-distance transmitter may be a chip operating under the Bluetooth Standard, which transmits an appropriate signal. Owing to the Bluetooth Standard, a data exchange can take place based on a radio transmission which requires no visual link and has a range of 10 m.

Within the signal emitted, a unique identification number assigned to each security system is contained, which is sent by the transmitter unit assigned to the security system and received by all receiver units of the security system.

It is preferable for the transmitter unit itself to be a radio set and responder, designated a transponder.

The invention also relates to a portable device with a short-distance receiver and a reaction unit. The short-distance receiver regularly receives a signal emitted by a portable transmitter unit of a security system, and the reaction unit generates a warning signal and/or activates a blocking mode, which renders the portable device unusable if the shortdistance receiver does not receive a signal.

Furthermore, the invention relates to a security device with a receiver unit. The receiver unit contains a short-distance receiver with a restricted range, which regularly receives a signal transmitted by a transmitter unit. If the transmitter unit does not receive a signal, a reaction unit contained in the security unit generates a warning signal. The short-distance receiver may be a chip operating under the Bluetooth Standard, which receives a corresponding signal. Within the emitted signal, a unique identification number assigned to the security unit is contained, which the short-distance receiver receives.

In addition, the invention relates to a method for securing portable devices. With the method, the transmitter unit regularly transmits a signal. The signal is regularly received by the receiver unit. A reaction unit generates a warning signal and/or activates a blocking mode, which renders the portable device unusable if the receiver unit does not receive any signal transmitted by the transmitter unit.

The invention will be further described with reference to examples of embodiments shown in the drawings, to which, however, the invention is not restricted.

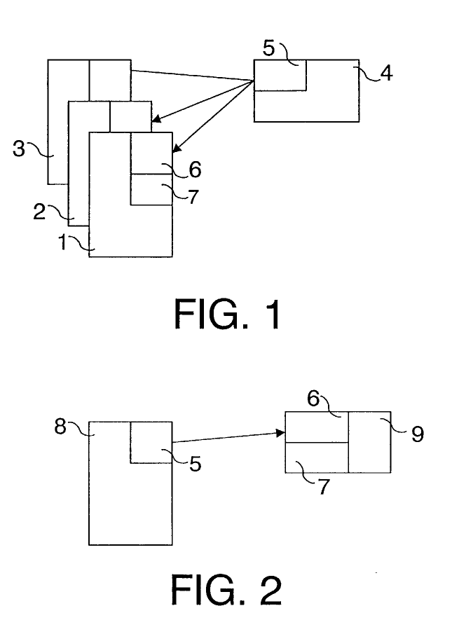

FIG. 1 shows three portable devices which are protected by a short-distance transmitter.

FIG. 2 shows a transmitter unit in the device to be protected.

In a first example of embodiment shown in FIG. 1, an owner is securing his three portable devices, a mobile phone 1, a walkman 2 and a personal digital assistant (PDA) 3, by means of a transmitter unit worn separately on his body. The transmitter unit is a portable short-distance transmitter 4, which contains, inter alia, a first chip 5, operating under the Bluetooth Standard. Owing to the Bluetooth Standard, a cordless connection of various devices can be realized. The Bluetooth Standard is hereby based on a radio transmission in which a visual link between the devices is not necessary, and which has a range of 10m.

In addition to their components that are important for their operation, the mobile phone 1, the walkman 2 and the PDA 3 contain a receiver unit and a reaction unit 7, which executes appropriate functions to protect the devices if chip 6 does not receive a signal. The receiver unit consists of a second chip 6 operating under the Bluetooth Standard, which receives an identification number from transmitter unit 4, previously registered in chip 6.

The identification number registered in chip 6 may have been registered during the production of transmitter unit 4, so that the owner has purchased the transmitter unit already equipped with an identification number. The registration may also be undertaken dynamically by the owner, for instance by pressing a button on the portable device or by simultaneously pressing a button on the portable device and the transmitter unit if both are within range. The registration may be combined with other procedures of the portable device, e.g. entering a PIN. In the same way, it can also be possible to cancel the registration on a time basis.

Once the same identification number has been registered in chip 6 of the mobile phone, the PDA and chip 6 of the walkman, the short-distance transmitter 4 regularly transmits a high frequency short-distance signal within a restricted range. The short-distance signal contains the identification number, which is regularly received by chip 6 integrated with mobile phone 1, walkman 2 and PDA 3. Both the short-distance transmitter 4 as well as the mobile phone 1, the walkman 2 and the PDA 3 are located on the owner's body.

As a result of the owner's location change or the theft of mobile phone 1, this is no longer located on the owner's body, and is far enough away that the range of the transmitted short-distance signal is exceeded. Since the short-distance signal is no longer received by mobile phone 1, reaction unit 7 of mobile phone 1 generates a loud warning signal, which is stopped after a period of time and, where applicable, is again generated when the mobile phone again receives the short-distance signal.

Simultaneously, the reaction unit 7 switches mobile phone 1 into a blocking mode in which it is unusable. In blocking mode, mobile phone 1 waits for a limited period for a renewed reception of the short-distance signal, or the owner may reactivate the mobile phone by executing an inputting procedure, such as inputting the PIN to the mobile phone. The mobile phone will resume operability after a delay.

The short-distance transmitter 4 may be used as a piece of jewelry and worn by the owner as a pendant on a neck chain, separately from the devices to be secured.

A second example of embodiment is used in a retail outlet for several digital cameras. On a counter in the retail outlet, several digital cameras are offered for sale. Each digital camera contains as a receiver unit a chip 6, operating according to the Bluetooth Standard, and a reaction unit 7, which executes appropriate functions if chip 6 does not receive a signal.

The digital cameras are located within a range of short-distance transmitter 4, which contains, inter alia, a chip 5, operating under the Bluetooth Standard, as the transmitter unit, and transmits a short-distance signal. An identification number is registered in chip 6 of each receiver unit. The same identification number is transmitted by the short-distance transmitter 4 as the short-distance signal.

The digital cameras may be used, undisturbed, by a prospective purchaser, and removed from the counter. As soon as a purchaser illegally removes a digital camera from the retail outlet, and thereby exceeds the range of the short-distance signal transmitted by the short-distance transmitter 4, the reaction unit 7 generates a loud warning signal and switches the digital camera into a blocking mode in which the digital camera is unusable. When a digital camera is sold, the receiver unit can be removed, or the camera is sold with a separate transmitter unit which is registered to the same identification number as the camera's receiver unit.

A third example of embodiment is described with reference to FIG. 2. Here, chip 5 is located as a transmitter unit within a car key 8. Chip 6, as the receiver unit of the identification number transmitted by chip 5, is integrated with a security unit 9 with the reaction unit 7.

The security unit 9 is carried by the car key's owner separately from the car key. The chip 5 integrated with the car key regularly transmits the identification number. If the owner of car key 8 loses it without realizing this, and chip 6 of security unit 9 does not receive the identification number, a warning signal generated by the reaction unit sounds. The owner becomes aware of the loss of car key 8 and can take appropriate action.

1. A security system for portable devices (1 to 3, 8), consisting of at least a portable transmitter unit (5) and at least a portable receiver unit (8), in which each transmitter unit (5) is provided for the regular transmission of a signal, each receiver unit (6) is provided, within a range of the signal, for the regular reception of the signal transmitted by the transmitter unit (5), and a reaction unit (7) is provided for generating a warning signal and/or for activating a blocking mode, which renders a portable device to be protected (1 to 3, 8) unusable if the receiver unit (6) does not receive a signal.

2. A security system as claimed in claim 1, characterized in that a short-distance transmitter integral with the portable transmitter unit (5) is provided for generating the signal.

3. A security system as claimed in claim 1, characterized in that the signal is a short-distance signal operating under the Bluetooth Standard.

4. A security system as claimed in claim 1, characterized in that an identification number is provided in the signal for identification of the security system.

5. A security system as claimed in claim 1, characterized in that the transmitter unit (5) is a transponder.

6. A portable device (1 to 3) comprising:
a short-range receiver (6) which is provided for the regular reception of a signal emitted by a portable transmitter unit (5) of a security system, and
a reaction unit (7) for generating a warning signal and/or for activating a blocking mode which renders the portable device unusable if the short-range receiver does not receive any signal.

7. A security unit (9) comprising:
a receiver unit (6) for the regular reception of the signal emitted by a transmitter unit (5), and
a reaction unit (7) for generating a warning signal is the receiver unit (6) does not receive a signal.

8. A method for securing portable devices (1 to 3, 8) in which:
a signal is regularly emitted by at least one portable transmitter unit (5),
the signal is regularly received by at least one receiver unit (6), and
a warning signal is generated and/or a blocking mode rendering a portable device (1 to 3, 8) unusable is activated if the receiver unit (6) does not receive any signal.
